(19) United States
(12) Patent Application Publication
(10) Pub. No.: US 2004/0133615 A1
(43) Pub. Date: Jul. 8, 2004

(54) Data processing apparatus for used in FFT/IFFT and method thereof

(76) Inventors: Huan-Tang Hsieh, (US); Cheng-Tai Chen, (US); Shyuan Liao, (US); Pei-Chieh Hsiao, (US)

Correspondence Address: BIRCH STEWART KOLASCH & BIRCH, PO BOX 747, FALLS CHURCH, VA, 22040-0747, US

(21) Appl. No.: 10/739,321

(22) Filed: Dec. 19, 2003

(30) Foreign Application Priority Data
Dec. 20, 2002 (TW) 091136896

(51) Int. Cl. G06F 15/00

(52) U.S. Cl. 708/404

(57) ABSTRACT

A data processing method of fast Fourier transform/inverse Fourier transform (FFT/IFFT) performed by a FFT/IFFT processor for used in a communication system is also disclosed. The FFT/IFFT processor includes a plurality of butterfly addition (BF) stages, the data includes a plurality of points, and each point includes a sign bit, at least one integral bit, and a plurality of decimal bits. The method comprises the steps of determining an overflow may occur in which of the BF stages when performing butterfly addition on the points of the data through detecting a preamble signal; and reserving one of the decimal bits of each point of the data to be an additional integral bit before performing the butterfly addition by the BF stage in which the overflow may occur.

### BACKGROUND OF THE INVENTION

(a). Field of the Invention

The present invention relates in general to a data processing apparatus for used in FFT/IFFT and a method thereof, and more particularly to a data processing apparatus for used in FFT/IFFT with high accuracy and a method thereof.

(b). Description of the Prior Arts

For discrete Fourier transform (DFT) and inverse discrete Fourier transform (IDFT), a large number of data processing is needed if there are a lot of points to be processed in a data sequence. In order to decrease the number of data processing (i.e. to save time for calculation), fast Fourier transform (FFT) and inverse fast Fourier transform (IFFT) are suggested. For example, if it takes 2ⁿ×2ⁿ of data processing number for processing a sequence of 2n points through DFT, it only needs n×2ⁿ of data processing number through FFT. The number of data processing can be greatly reduced when n is a rather large number.

However, the problem of overflow, which is due to the value of data in process out of the data format of the FFT/IFFT processor, may occur when executing FFT/IFFT. FIG. 1A is a diagram showing the architecture of a FFT/IFFT processor capable of processing a 512-point data sequence. In FIG. 1A, the input data of the processor has a 16-bit input data format, and the output data of the processor has a 20-bit output data format. Each of BF blocks represents an operation of butterfly addition and each of MP blocks represents an operation of twiddle factor multiplication.

The format of the 16-bit input data is expressed as 1.15, where “0.15” means that the input data contains fifteen decimal bits, and “1” represents the sign bit. When the butterfly addition is performed on two points of 16-bit data, it takes 17 bits to fully express the result of the operation if there is a carry. Thus, the data format may become 2.15, which means a sign bit, an integer bit (for carry) and fifteen decimal bits in order. In other words, the data format may be increased by one integer bit after the butterfly addition is executed. In FIG. 1A, when a 16-bit data is passed through the first four addition (BF) stages, it would take 20 bits to fully express the result of the butterfly addition if the carry is generated in all four BF stages. Thus, the data format becomes 5.15. In this manner, if there is a carry generated in any one of the subsequent addition (BF) stages, the output data must be larger than 20 bits, which is out of the range of the output data format. Thus, the problem of overflow may occur and the accuracy of FFT/IFFT operation may be degraded.

### SUMMARY OF THE INVENTION

In view of the above issue, an object of the present invention is to provide a data processing system for performing fast Fourier transform/inverse Fourier transform (FFT/IFFT) of a plurality of 2ⁿ point data sequences in which the overflow problem can be avoided.

Based on the object of the present invention, a data processing system of a communication system for performing fast Fourier transform/inverse Fourier transform (FFT/IFFT) on a plurality of data sequences with 2ⁿ points is disclosed. The FFT/IFFT processor includes a plurality of butterfly addition (BF) stages and each point of the data at least includes a sign bit, at least one integral bit, and a plurality of decimal bits. The FFT/IFFT system disclosed in the embodiment of the present invention comprises a multiplexer for time-divisionally outputting the data sequences; a FFT/IFFT processor for performing FFT/IFFT on the data sequences, wherein the FFT/IFFT processor may reserve one of the decimal bits of each point of the data for to be an additional integral bit before performing the butterfly addition by the BF stage in which the overflow may occur based on a overflow parameter obtained by detecting a preamble signal before the data transmission; and a demultiplexer for time-divisionally outputting a FFT/IFFT result of the each data sequences from the FFT/IFFT processor.

A data processing method of fast Fourier transform/inverse Fourier transform (FFT/IFFT) performed by a FFT/IFFT processor for used in a communication system is also disclosed. The FFT/IFFT processor includes a plurality of butterfly addition (BF) stages, the data includes a plurality of points, and each point includes a sign bit, at least one integral bit, and a plurality of decimal bits. The method comprises the steps of determining an overflow may occur in which of the BF stages when performing butterfly addition on the points of the data through detecting a preamble signal; and reserving one of the decimal bits of each point of the data to be an additional integral bit before performing the butterfly addition by the BF stage in which the overflow may occur.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a diagram showing the conventional FFT/IFFT processor capable of processing 512-point data sequences.

FIG. 1B is a block diagram of a FFT/IFFT data processing system according to the preferred embodiment of the present invention.

FIG. 2 is a flow chart showing a method for FFT/IFFT data processing according to the preferred embodiment of the present invention.

### DETAILED DESCRIPTION OF THE EMBODIMENT OF THE PRESENT INVENTION

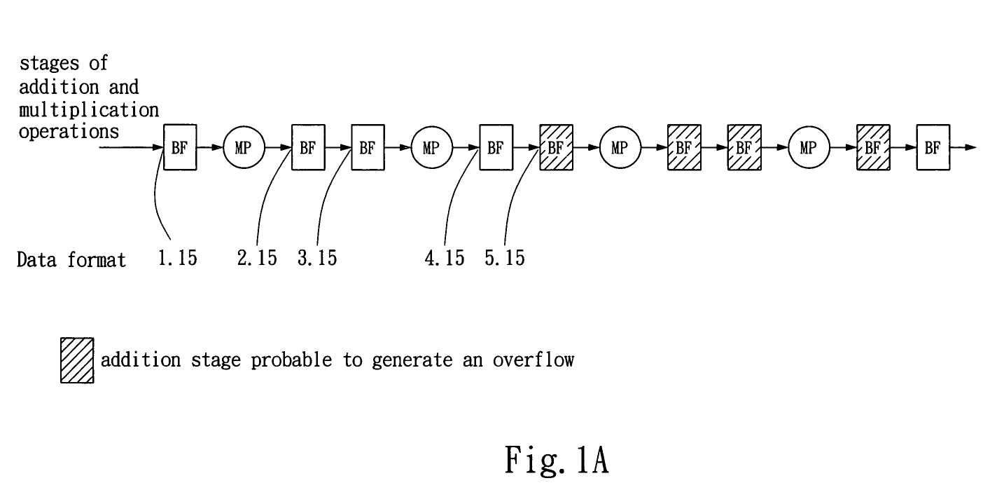

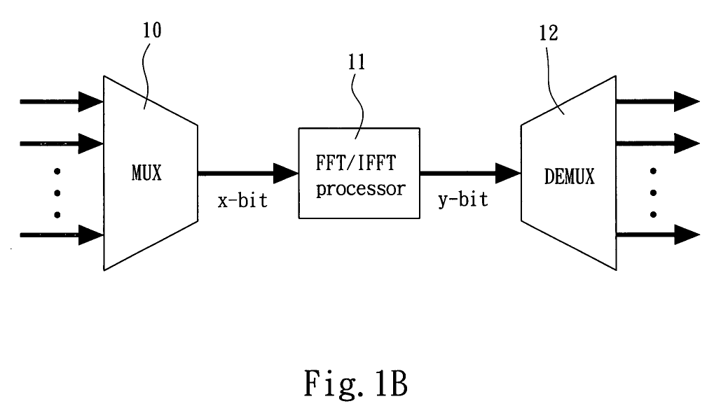

FIG. 1B is a block diagram of the FFT/IFFT data processing system according to the preferred embodiment of the present invention. The processing system includes a multiplexer 10, a FFT/IFFT processor 11 and a demultiplexer 12. The multiplexer 10 receives a plurality of data sequences and time-divisionally outputs data sequences to the FFT/IFFT processor 11 according to a control signal. The FFT/IFFT processor 11 performs FFT/IFFT operation on each of the data sequences outputted from the multiplexer 10 and outputs a FFT/IFFT result of each data sequence to the demultiplexer 12. The demultiplexer 12 time-divisionally outputs the FFT/IFFT result of each data sequence according to the control signal. In this embodiment, the control signal is a periodical signal to simultaneously control the operation of the multiplexer 10 and the demultiplexer 12.

Each data sequence contains 2ⁿ-point of data. The most significant bit (MSB) of each point of data is a sign bit and the remaining bits represent an integer part and a decimal part in order. The FFT/IFFT processor 11 can process 2ⁿ-point of data at a time. The FFT/IFFT processor 11 has an x-bit input and a y-bit output, where y>x and n−1>y−x. In this embodiment, x=16, y=20, and n>5. The FFT/IFFT processor 11 includes n BF stages. It should be noted that based on the description of the convention art, the overflow problem does not happen in the first four BF stages, the overflow may happen only in the last (n−4) BF stages in this embodiment. In addition, the last (i.e. n-th) BF stage is not taken into consideration in this embodiment in order to reduce hardware cost and to improve calculation speed. Therefore, only the (y−x+1)th to the (n−1)th BF stages are taken into consideration.

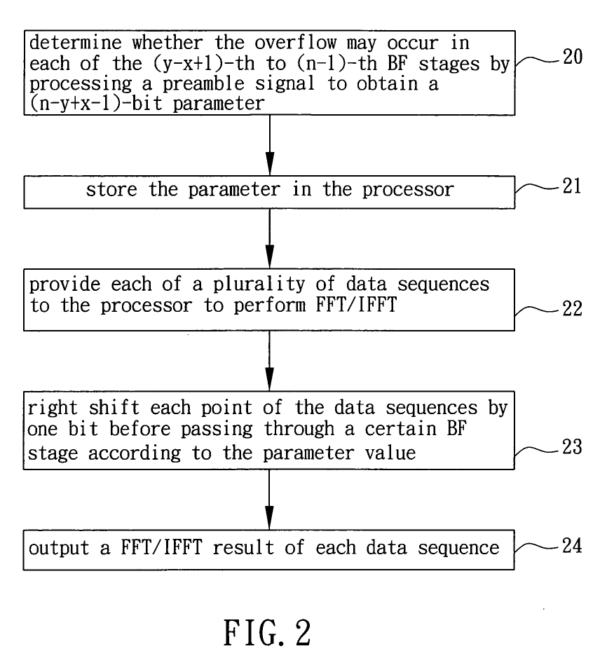

FIG. 2 is a flow chart showing a method of FFT/IFFT data processing accozrding to the preferred embodiment of the present invention. As shown in FIG. 2, the processing method employs the system of FIG. 1B to perform steps of:

20 determining whether the overflow may occur in each of the (y−x+1)-th to (n−1)-th BF stages by processing a preamble signal to obtain a (n−y+x−1)-bit parameter, wherein each bit of the parameter indicates that the overflow may occur in the (y−x+1)-th to (n−1)-th BF stages respectively;

21 storing the parameter in the processor 11;

22 providing each of a plurality of data sequences to the processor 11 to perform FFT/IFFT;

23 right shifting each point of the data sequences by one bit before passing through a certain BF stage according to the parameter value; and

24 outputting a FFT/IFFT result of each data sequence.

In step 20, the FFT/IFFT processor 11 of this embodiment performs the FFT/IFFT operation on the preamble signal first. The format of the preamble signal may be varied depends on the protocol of communication system. However, for the specific communication systems, the transmitting end must send a preamble signal with a specific format to the receiving end before the data transmission. In this embodiment of the present invention, the overflow may occur in which BF stages can be determined based on the energy level represented by the preamble signal, which can be detected through performing the FFT/IFFT operation on the preamble signal by the FFT/IFFT processor 11. In the embodiment, which BF stages are probably to generate the carry through performing the BF addition can be represented by a (n−y+x−1)-bit overflow parameter of the FFT/IFFT processor 11. Each bit of the overflow parameter indicates that the overflow may occur in the (y−x+1)-th to (n−1)-th BF stages respectively. In step 21, the overflow parameter can be stored in the register of the FFT/IFFT processor 11.

In the step 22, as mentioned above, each data sequence contains 2ⁿ-point of data, and the most significant bit of each point of data is a sign bit while remaining bits represent an integer part and a decimal part in order.

In the present invention, if the overflow parameter indicates that a certain BF stage is likely to generate a carry, then each point of data is right shifted by one bit before performing the BF addition. In this manner, the possible overflow problem can be avoided with the price of the little error resulted from abandoning the least significant bit (LSB) of the decimal part.

In the step 23, if the overflow parameter indicates that a certain BF stage is likely to generate a carry, then each point of data is right shifted by one bit before performing the BF addition to reserve one empty bit for a possible carry generated after the BF addition is performed. For example, if the overflow parameter obtained in the step 20 indicates that the fifth BF stage may generate a carry, then the data format is pre-adjusted to 6.14 before performing the BF addition by the fifth BF stage. That is, one bit in the decimal part of each point of data is sacrificed while one extra bit in the integer part is obtained to express a possible carry. Therefore, under the given hardware limitation, the overflow problem can be avoided and the FFT/IFFT accuracy is substantially improved at the price of losing the accuracy at the least significant bit of the decimal part.

While the present invention has been shown and described with reference to the preferred embodiments thereof and in terms of the illustrative drawings, it should not be considered as limited thereby. Various possible modifications and alterations could be conceived of by one skilled in the art to the form and the content of any particular embodiment, without departing from the scope and the spirit of the present invention.

What is claimed is:

1. A data processing method of fast Fourier transform/inverse Fourier transform (FFT/IFFT) performed by a FFT/IFFT processor for used in a communication system, wherein the FFT/IFFT processor includes a plurality of butterfly addition (BF) stages, the data includes a plurality of points, and each point includes a sign bit, at least one integral bit, and a plurality of decimal bits, the method comprising:
determining an overflow may occur in which of the BF stages when performing butterfly addition on the points of the data through detecting a preamble signal; and
reserving one of the decimal bits of each point of the data to be an additional integral bit before performing the butterfly addition by the BF stage in which the overflow may occur.

2. The data processing method of claim 1, wherein the preamble signal is detected by performing FFT/IFFT on the preamble signal.

3. The data processing method of claim 1, wherein the format of the preamble signal is corresponding to the protocol of the communication system.

4. The data processing method of claim 1, wherein the sign bit is the most significant bit.

5. The data processing method of claim 1, wherein the reserving step comprises:
right shifting the decimal bits by one bit to provide the additional integral bit; and
abandoning the least significant bit (LSB) of the decimal bits.

6. The data processing method of claim 1, further comprising:
performing the FFT/IFFT by the BF stage; and
recording by the additional integral bit if the overflow occurs in the BF stage when performing butterfly addition.

7. The data processing method of claim 1, wherein an input data of the FFT/IFFT processor includes x bits, an output data of the FFT/IFFT processor includes y bits, and the FFT/IFFT processor at least includes n stages, wherein y>x and n−1>y−x.

8. A data processing system of a communication system for performing fast Fourier transform/inverse Fourier transform (FFT/IFFT) on a plurality of data sequences with 2ⁿ points, wherein the FFT/IFFT processor includes a plurality of butterfly addition (BF) stages and each point of the data at least includes a sign bit, at least one integral bit, and a plurality of decimal bits, the system comprising:
a multiplexer for time-divisionally outputting the data sequences;
a FFT/IFFT processor for performing FFT/IFFT on the data sequences, wherein the FFT/IFFT processor may reserve one of the decimal bits of each point of the data for to be an additional integral bit before performing the butterfly addition by the BF stage in which the overflow may occur based on a overflow parameter obtained by detecting a preamble signal before the data transmission; and
a demultiplexer for time-divisionally outputting a FFT/IFFT result of the each data sequences from the FFT/IFFT processor.

9. The data processing system of claim 8, wherein the FFT/IFFT processor comprises a register for storing the overflow parameter.

10. The data processing system of claim 8, wherein the overflow parameter detection is executed through performing the FFT/IFFT operation on the preamble signal by the FFT/IFFT processor.

11. The data processing system of claim 8, wherein the format of the preamble signal is corresponding to the protocol of the communication system.
